(19) United States
(12) Patent Application Publication
(10) Pub. No.: US 2010/0234774 A1
(43) Pub. Date: Sep. 16, 2010

(54) Exercise Machine With Vibration Board

(76) Inventor: Alexey Cheremsky, Dobbs Ferry, NY (US)

Correspondence Address: LOEB & LOEB, LLP, 321 NORTH CLARK, SUITE 2300, CHICAGO, IL, 60654-4746, US

(21) Appl. No.: 12/404,787

(22) Filed: Mar. 16, 2009

(51) Int. Cl. A61H 1/02

(52) U.S. Cl. 601/23

(57) ABSTRACT

The present invention relates to an apparatus and method for exercising and stretching muscles. The exercise machine of the invention is built on the concept of stretching muscles under vibration. This allows for a greater ease in stretching muscles, avoids pain, and keeps muscles relaxed and loose during the exercise period.

The present invention relates to an apparatus and method for exercising and stretching muscles. The exercise machine of the invention is relates to the use of exercises that stretch muscles under vibration. Combining exercise or stretching muscles with vibration allows for a greater ease in stretching muscles, avoids pain, and keeps muscles relaxed and loose during the exercise period.

### BACKGROUND OF THE INVENTION

Resistance training and stretching exercises use a range of equipment, such as weights, springs, and other devices, and are universally used methods of improving the strength and endurance of men and women, including athletes and sportspersons. Modifications and adaptations to known exercise devices were made in order to improve the effectiveness of resistance training.

The use of vibration applied to muscle or tendon induces a non-voluntary muscular contraction called the “tonic vibration reflex.” Strength training and stretching with additional vibration generally can augment strength and power over and above that achieved with exercise alone. This effect is achieved through the recruitment of additional muscle fibers above the normal recruitment level. In addition, vibration is becoming a common tool used in the retardation of muscle and bone atrophy on earth and in space. Previous strength training investigations utilized electric motor driven vibration devices that cause a non-smooth contraction of the muscles.

Current commercially available weight training devices rely either on unmodulated loads or full-body vibration. These methods apply no vibrational loading at all, or fail to directly apply specific frequencies to targeted muscle groups. Full body vibration devices are described, e.g., in U.S. Patent Application Publication Nos. 2007/0219052 A1; 2005/0250626 A1; and 2005/0219052 A1. The full-body vibration systems can also quickly lead to discomfort and other negative physical side-effects. Other exercise equipment that utilize vibration and electronic frequencies are described in U.S. Pat. Nos. 7,214,170 and 6,659,918, respectively.

Apparatuses have been described that consist of an electromotor with a speed reduction and eccentric wheel. The load is held by a cable which is passed through the eccentric wheel via pulleys. The eccentric rotation will elicit peak-to-peak oscillations and a specific frequency. Vibration from a two-arm handle is transmitted through the contracting muscles involved in the pulling action. However, the vibration is damped due to cable transmission. Such apparatuses are impractical for use by people in training under actual conditions because of the size of the equipment and the requirement for knowledge of electronics and mechanics.

This invention relates to an improved apparatus for enabling a vibration to be transmitted to a person during an exercise session.

### BRIEF SUMMARY OF THE INVENTION

The exercise machine comprises a vibration board, at least one tie, at least one pulley, at least one base with a fastener, at least one sleeve or cuff, at least one karabiner, a channel strut, and at least one slider or wheel. Other components may be optionally included in the exercise machine, e.g., a backrest, a rope for connecting parts of the exercise machine and a conventional electric cord and plug. The ties may be ratchet ties, or other ties known in the art. The exercise machine may also comprise an ottoman accessory for use in exercises where the legs placed straight in front of a user.

The invention also relates to a method of using an exercise machine. This method comprises sitting on the vibration board of the exercise machine, securing the at least one sleeve or cuff with the at least one fastener, tying the at least one ratchet tie until tension is felt in the muscles of the leg or arm, plugging in the vibration board, and tightening the at least one fastener when the muscles of the leg or arm feel loose. The method can further include unlocking the at least one ratchet tie upon completion of the exercise session. The method of the invention can be repeated at least one time in order to optimize a user's exercise routine.

The invention further relates to a vibration board exercise stretching apparatus wherein several different muscle groups can be exercised. The configuration of the apparatus can be altered by using different accessories, dependent upon the desired muscle group to be exercised.

Other systems, methods, features, and advantages of the present invention will become apparent to one with skill in the art upon examination of the following figures and detailed description. All such additional systems, methods, features, and advantages are included within this description and the scope of the invention, and are protected by the accompanying claims. Accordingly, the present invention should not be restricted except in light of the attached claims and their equivalents.

### BRIEF DESCRIPTION OF THE FIGURES

The accompanying drawings, which are incorporated in and constitute a part of this specification, illustrate an implementation of the present invention and, together with the description, serve to explain the advantages and principles of the invention. In the drawings:

FIG. 1 depicts the exercise equipment of the invention.

FIG. 2 depicts the exercise equipment of the invention with an ottoman accessory.

FIG. 3 depicts the ottoman accessory of the invention.

FIG. 4 depicts a user exercising in a sitting position.

FIG. 5 depicts a user exercising using the ottoman accessory.

FIG. 6 depicts a user exercising in a standing position.

FIG. 7 depicts another illustration of the exercise equipment of the invention.

### DETAILED DESCRIPTION OF THE INVENTION

Methods and systems consistent with the present invention allow for a person to exercise using an apparatus that employs vibration. In addition to providing a means for exercise, these systems and methods also provide for more efficient and healthy ways of exercising.

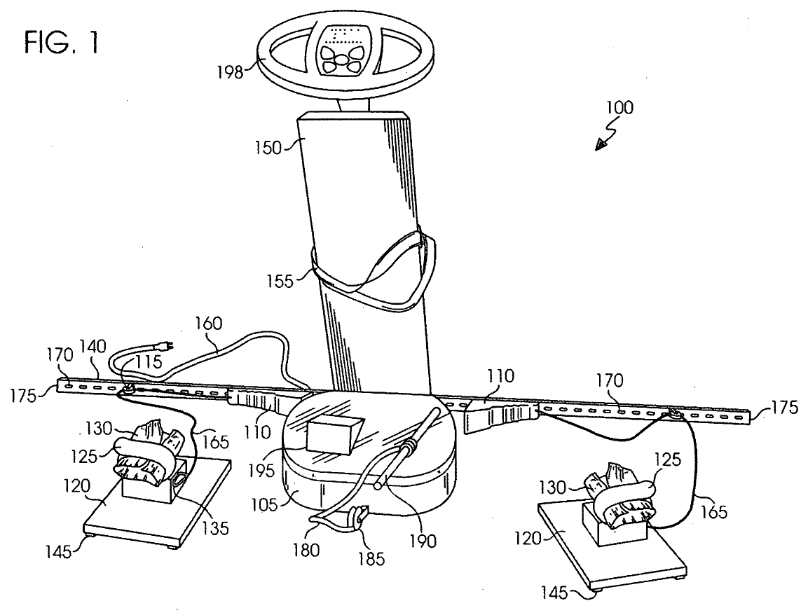

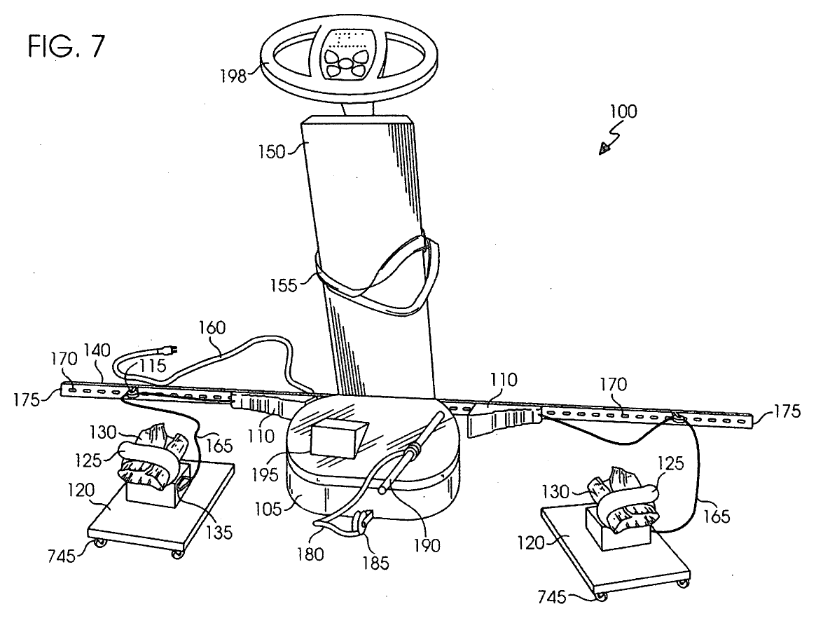

FIG. 1 depicts a system 100 suitable for practicing the methods consistent with the present invention. The system 100 includes a vibration board 105, at least one tie 110, at least one pulley 115, at least one base 120 with a fastener 125, at least one sleeve or cuff 130, at least one karabiner 135, a channel strut 140, and at least one slider 145. FIG. 1 also shows the at least one fastener 125 positioned on top of the at least one base 120. Alternatively, the slider 145 can be replaced by a wheel 745, as seen in FIG. 7, for use on different types of flooring. In addition, the channel strut 140 may be adjustable back and forth to obtain a negative angle of stretching.

FIG. 1 also shows that the exercise system may also include a backrest 150. The backrest 150 may be adjustable and padded. The backrest 150 may also have an adjustable strap 155 at knee level. The knee strap 155 may provide support and resistance. The backrest can have an additional security strap at the thigh level (not shown). The at least one tie 110 can be a ratchet tie. The at least one fastener is used to secure at least one sleeve, or cuff 130 around a leg or arm. The sleeve, or cuff, 130 may be padded. Alternatively, the vibration board 105 can be electric and can be plugged into an electrical source with a conventional electric cord and plug 160.

The exercise system further includes a rope 165, which attaches the at least one base to the at least one ratchet tie 110. The rope 165 is threaded through the at least one pulley 115 and is attached to the at least one ratchet tie 110. The at least one ratchet tie 110 and at least one pulley 115 are attached to the channel strut 140. The channel strut 140 has holes 170 for adjusting the at least one pulley 115. The at least one pulley 115 is attached to the channel strut 140 by a pin 175.

The rope 165 is attached in the other end to the at least one karabiner 135 The at least one karabiner is then attached to the at least one base 120, as shown in FIG. 1. At least one slider 145 is located on the bottom of the at least one base 145, as also shown in FIG. 1. Alternatively, the slider 145 can be replaced by a wheel 745, as seen in FIG. 7, for use on different types of flooring.

FIG. 1 also shows that the exercise system may further include a second rope 180, which may be used for a second stretching position. This rope is fed through a large pulley 185 and connected to a handlebar 190. The handlebar 190 can be grasped by the user during the process of exercising and stretching. The vibration board 105 can also comprise motor and gear system (not shown). The motor can be used to reel in and release the second rope 180. The motor can be controlled remotely by forward and reverse buttons on the handlebar 190.

FIG. 1 additionally shows that the exercise machine can further comprise one or more wedge-shaped accessories 195. These wedge-shaped accessories can be placed on the vibration board 105 in order for a user to stretch and exercise the calf muscles.

In another aspect of the invention, the stretching apparatus can be assembled on a with a commercial computerized system 198 as an additional device. The computerized system can track and display such items including, but not limited to, at least one user's exercise profile, at least one user's exercise log, information from a specific exercise session, or can control a specific exercise session. Alternatively, the stretching apparatus can be used as a stand-alone or independent stretching machine, under control of the user.

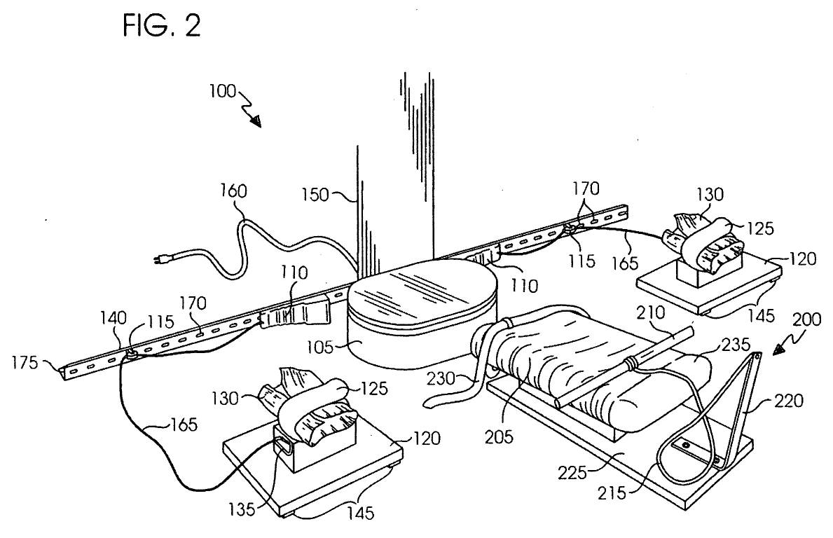

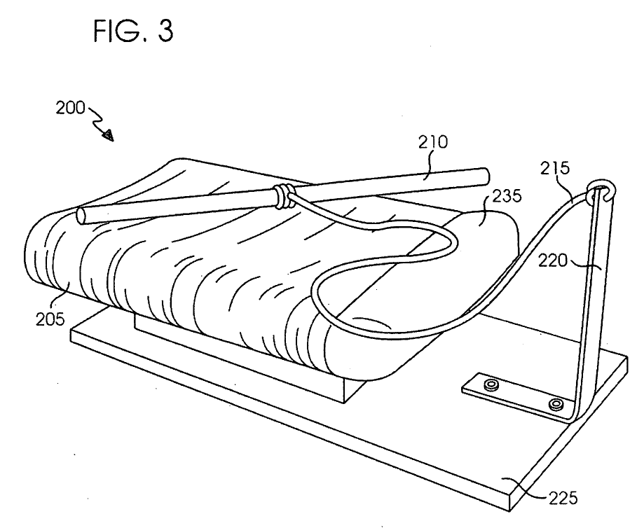

In another aspect of the invention, the stretching apparatus may include an ottoman accessory 200, as shown in FIG. 2. The ottoman accessory 200 is a cushioned platform 205 with a handle bar 210 attached to a rope 215. The handle bar 210 may be square or triangular, which reduces the amount of pressure on the user's hand grip. The rope 215 coming from the handle bar 210 may be attached to a bracket 220 at the base 225 of the ottoman. The ottoman may also have a strap 230 which can be used to strap the user's legs to the accessory. This strap can prevent a user from bending his or her knees during the stretch. Further, a bolster 235 on the end of platform 205 prevents a user's heels from sliding off of the ottoman accessory 200. A close-up view of the ottoman accessory 200 is provided in FIG. 3.

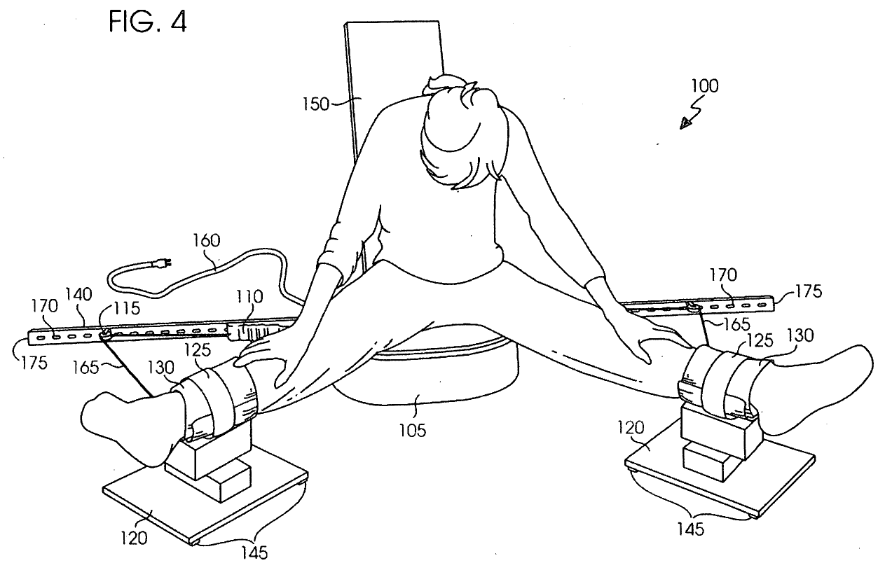

The invention also encompasses a method of exercising using the exercise system as described. FIGS. 4-6 depict a user exercising on the apparatus 100 in a sitting position, using an ottoman accessory 200 and in a standing position, respectively.

FIG. 4 shows that the invention can be used by employing a method of exercising comprising sitting on the vibration board of the exercise machine, securing the at least one sleeve, or cuff 130 around a leg or arm with the at least one fastener 125, tying the at least one ratchet tie 110 until tension can be felt in the muscles of the leg or arm, plugging in the electric wire/plug 125 of the vibration board 105; and tightening the at least one fastener when the muscles of the leg or arm feel loose. The method can further include unlocking the at least one ratchet tie 110 upon completion of the exercise session. The method of the invention can be repeated at least one time in order to optimize a user's exercise routine. This exercise is a version of the “sit and reach hamstring stretch.”

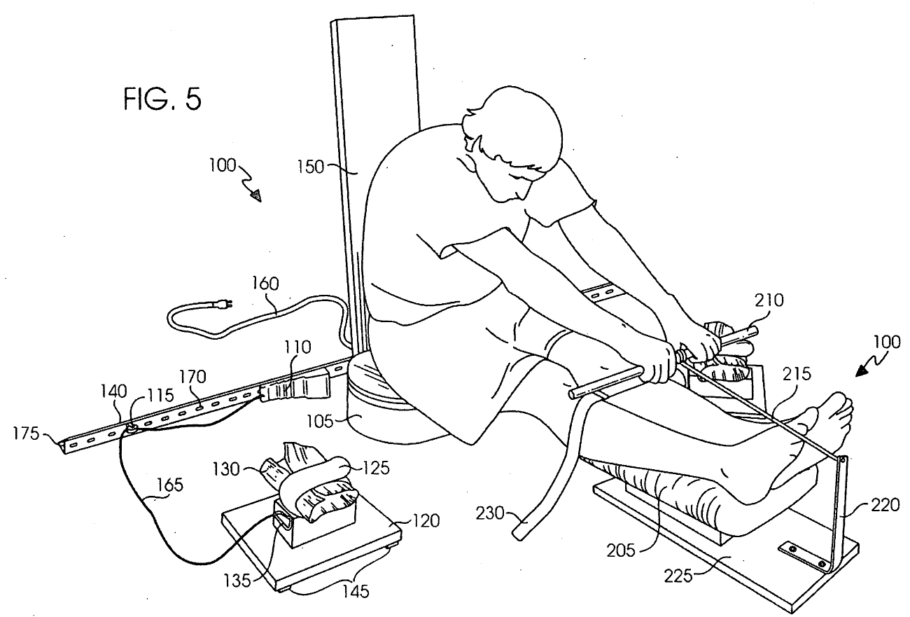

FIG. 5 depicts another variation of the “sit and reach hamstring stretch” uses an ottoman accessory 200. For this variation of the “sit and reach hamstring stretch” exercise, the user can sit on the vibrastretch machine with their legs straight on the ottoman accessory 200. The user can increase the intensity of the hamstring stretch by manually rotating the handle bar 210 of the ottoman accessory 200.

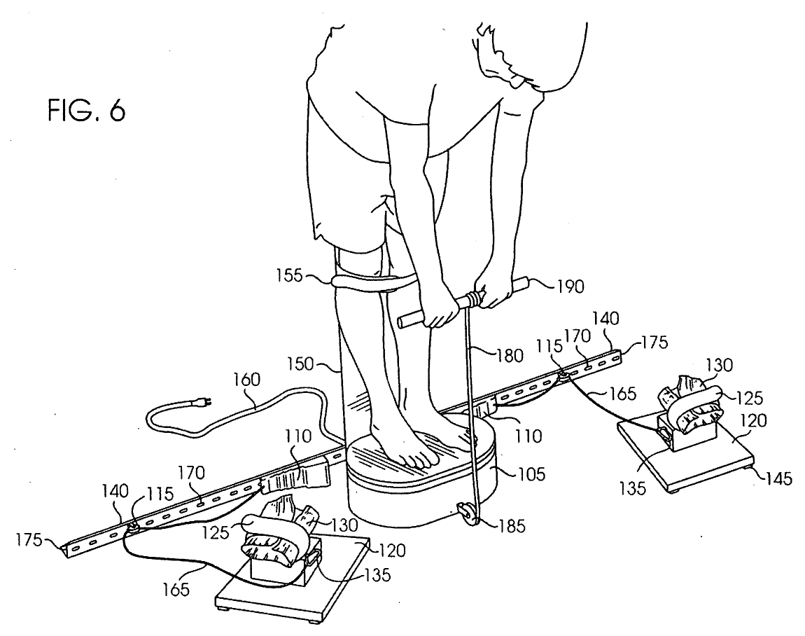

FIG. 6 shows a different type of stretch that can be performed by a user, wherein the user stands on top of the vibration board 105, bending forward to grasp the handlebar 190 with the hands, and straighten up to stretch the desired muscles of the back and legs. The intensity can be increased or decreased by using the forward and reverse buttons on the handlebar 190. Alternatively, the intensity of the exercise can be increased or decreased by manually rotating the handlebar 190. If necessary, the handlebar 190 can be released by the user in the event of an emergency. Alternatively, this stretch can be performed using gravity rather than the handlebar 190 configuration. The legs can be strapped to the backrest 150 using the knee strap 155. The method of the invention can be repeated at least one time in order to optimize a user's exercise routine.

Another type of stretch that can be performed uses the two wedge-shaped accessories 195, which can be attached to the vibration board 105. These wedge-shaped accessories 195 can be placed under the front of the foot to perform the stretching exercise. The wedge-shaped accessories 195 can be adjustable so the user can set the intensity of the stretch. This stretch focuses specifically on the calf muscles. Prior to mounting the stretching machine of the invention, the user can attach one or both wedge-shaped accessories 195 to the top of the vibration board 105. The user stands on top of the vibration board 105 and places one foot on top of the wedge-shaped accessory 195 and the other flat on the vibration board 105. The user could then switch feet to stretch the other calf muscle. Alternatively, both calf muscles could be stretched at the same time by placing both feet on the wedge-shaped accessories 195. The method of the invention can be repeated at least one time in order to optimize a user's exercise routine.

The foregoing description and drawings merely explain and illustrate the invention and the invention is not limited thereto. While the specification in this invention is described in relation to certain implementation or embodiments, many details are set forth for the purpose of illustration. Thus, the foregoing merely illustrates the principles of the invention. For example, the invention may have other specific forms without departing from its spirit or essential characteristic. The described arrangements are illustrative and not restrictive. To those skilled in the art, the invention is susceptible to additional implementations or embodiments and certain of these details described in this application may be varied considerably without departing from the basic principles of the invention. It will thus be appreciated that those skilled in the art will be able to devise various arrangements, which, although not explicitly described or shown herein, embody the principles of the invention and, thus, are within its scope and spirit. All patents, patent applications, and publications cited herein are fully incorporated by reference in their entirety.

What is claimed is:

1. An exercise machine comprising:
an vibration board;
at least one tie;
at least one pulley;
at least one base with a fastener;
at least one sleeve or cuff;
at least one karabiner;
a channel strut; and
at least one slider or wheel.

2. The exercise machine of claim 1, further comprising a backrest.

3. The exercise machine of claim 1, wherein the at least one tie is a ratchet tie.

4. The exercise machine of claim 3, wherein the at least one ratchet tie is attached to the channel strut.

5. The exercise machine of claim 1, wherein the at least one karabiner is attached to the at least one base with a fastener.

6. The exercise machine of claim 5, wherein the fastener is padded.

7. The exercise machine of claim 1, further comprising holes for adjustment of the at least one pulley.

8. The exercise machine of claim 7, wherein the at least one pulley is attached to the channel strut with a pin.

9. The exercise machine of claim 1, wherein the vibration board is electric and can be plugged into an electrical source with a conventional electric cord and plug.

10. The exercise machine of claim 1, further comprising a large pulley, a second rope and a handlebar, wherein said large pulley, second rope and handlebar are operatively connected.

11. The exercise machine of claim 1, further comprising wedge-shaped accessories configured to be used in stretching exercises.

12. The exercise machine of claim 1, wherein said machine further comprises a computerized system.

13. The exercise machine of claim 1, wherein said machine can be used as a stand-alone exercise stretching apparatus.

14. The exercise machine of claim 1, further comprising an ottoman accessory.

15. The exercise machine of claim 14, wherein the ottoman accessory comprises a platform operably connected to a base; a strap; a bolster; and a handlebar operably connected to a bracket.

16. A method of exercising comprising:
sitting on the vibration board of the exercise machine of claim 1;
securing the at least one sleeve or cuff with the at least one fastener;
tying the at least one ratchet tie until tension is felt in the muscles of the leg or arm;
plugging in the vibration board; and
tightening the at least one fastener when the muscles of the leg or arm feel loose.

17. The method of claim 16, further comprising:
unlocking the ratchet tie upon completion of the exercise session.

18. The method of claim 16, wherein the exercise is repeated at least one time.

19. A method of exercising comprising:
sitting on the vibration board of the exercise machine of claim 14;
placing the legs on a platform of an ottoman accessory;
securing the legs onto the platform of the ottoman accessory with a strap;
plugging in the vibration board;
grasping a handlebar of the ottoman accessory; and stretching the legs.

20. The method of claim 19, wherein the exercise is repeated at least one time.

21. A method of exercising comprising:
standing on the vibration board of the exercise machine of claim 10;
bending forward;
grasping the handlebar with the hands; and
straightening from a bending position to a standing position, whereby the muscles of the back and legs are stretched.

22. The method of claim 21, wherein the exercise is repeated at least one time.

23. A method of exercising comprising:
standing on the vibration board of the exercise machine of claim 11;
placing at least one wedge-shaped accessory under at least one foot;
and stretching the muscles of the calf.

24. The method of claim 23, wherein the exercise is repeated at least one time.
